(19) United States
(12) Patent Application Publication
(10) Pub. No.: US 2011/0180171 A1
(43) Pub. Date: Jul. 28, 2011

(54) OBSTRUCTIVE CAP FOR A ROTATING HOLLOW TRANSMISSION SHAFT

(75) Inventors: FRANÇOIS GALLET, Paris (FR); IVAN ROUESNE, Combs-la-Ville (FR)

(73) Assignee: SNECMA, Paris (FR)

(21) Appl. No.: 12/960,000

(22) Filed: Dec. 3, 2010

(30) Foreign Application Priority Data
Dec. 4, 2009 (FR) 0958671

(51) Int. Cl. F16L 55/10

(52) U.S. Cl. 138/89

(57) ABSTRACT

A sealing plug for a hollow shaft used to impart a rotational speed, the hollow shaft including a first end adapted to be located in a chamber containing lubricant, and a second end adapted to be located outside the chamber. The sealing plug has a substantially cylindrical surface, a first face and a second face for insertion into the first end of the hollow shaft. The plug also includes a cavity that is open at the second face and a first radial duct opening, at one of its ends, at the cavity and, at its opposite end, at the substantially cylindrical surface of the sealing plug. The device is applied particularly in the field of turbomachines equipped with an open rotor.

The present invention relates to the field of sealing plugs. More specifically, the field of the invention relates to that of sealing plugs for hollow shafts used to impart a rotational speed within turbomachines equipped with an open rotor.

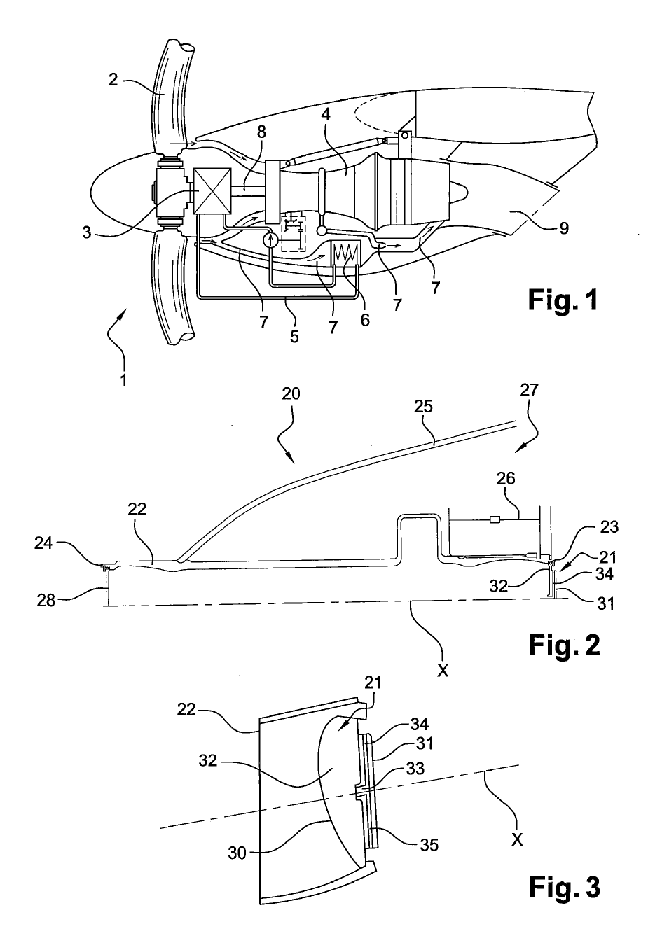

Patent document FR2788308, filed by the applicant, describes a turbine engine (FIG. 1) equipped in its upstream portion with a propeller 2 driven in rotation by a speed reducer 3, which speed reducer is in turn driven in rotation by a turbine 4. The speed reducer 3 is lubricated by a lubricating circuit 5 comprising, in particular, a radiator 6. A cooling circuit 7 also equips the turbine engine 1. This assembly formed of the cooling circuit 7 and radiator 6 makes it possible to ensure that the lubricant is kept at the desired temperature.

In flight, air infiltrates the cooling circuit 7, passes through the radiator 6 and is evacuated via a nozzle 9 arranged downstream of the turbine engine 1. This routing of the air makes it possible to cool the radiator 6 and thus the lubricant sufficiently in order to keep said lubricant at a suitable temperature.

In addition, during operation, a compressor (not shown) compresses the air entering from the outside so as to then inject this compressed air within a combustion chamber (not shown), into which a fuel is also injected. The hot gases thus formed become depressurised in the turbine 4 and are converted into mechanical energy for rotation of the turbine shaft 8, which rotates the reducer 3 and consequently the propeller 2. It should be noted that the hot gases escape from the turbine engine 1 via the nozzle 9 arranged downstream of the turbine engine 1. In other words, the reducer 3 of the turbine engine 1 is arranged in a cold zone, that is to say upstream of the turbine 4.

By contrast to the turbine engines described above, turbomachines equipped with an open rotor comprise a speed reducer arranged in a hot zone, that is to say downstream of the turbine. Open rotors generally comprise two external propellers devoid of any radial surrounding protective fairing. In order to drive these two propellers, a speed reducer is provided that is driven in rotation by a turbine shaft. More specifically, the speed reducer is arranged between the turbine and the two propellers. Furthermore, the reducer is positioned in a chamber filled with a mixture formed of air and lubricant in order to ensure lubrication of the various mechanical components comprised by said reducer. It should also be noted that the turbine shaft is hollow. Since the turbine shaft is hollow, hot air can circulate through the turbine towards the chamber and the lubricant can circulate through the chamber towards the turbine.

A drawback posed by this type of turbine shaft used for an open rotor is that the quality of the lubricant may be altered by an increase in temperature generated by the hot air, originating from the turbine, circulating within the turbine shaft. The deterioration in the quality of the lubricant may increase wear of mechanical components, for example gears and/or bearings contained in the chamber.

In addition, the lubricant may escape from the chamber by infiltrating the hollow portion of the shaft. Premature wear of mechanical components contained in the chamber may consequently then lead to a decrease in the amount of lubricant present in the chamber.

Furthermore, the lubricant may also collect in the hollow portion of the shaft and produce non-axisymmetric rotation.

A solution to the problems mentioned above could consist of plugging each end of the hollow shaft so as to thus prevent, on the one hand, infiltration of the hot air generated by the turbine and, on the other hand, infiltration of the lubricant contained in the chamber. However, the air trapped in the hollow shaft would lead to a difference in pressure between the outside and the inside of the shaft. This difference in pressure would subject said shaft to mechanical stress.

Furthermore, the value of this pressure that varies in particular as a function of temperature would not be known: not knowing this value would complicate dimensioning of the surrounding mechanical components considerably.

The object of the invention is therefore, more specifically, to overcome the drawbacks of the aforementioned devices. In this connection, the object of the invention is to propose a device adapted to balance the pressures prevailing inside and outside the hollow shaft whilst preventing lubricant from penetrating said shaft,

To this end, the invention relates to a sealing plug for a hollow shaft used to impart a rotational speed, said hollow shaft comprising:
a first end adapted to be located in a chamber containing lubricant;
a second end adapted to be located outside said chamber;

said sealing plug comprising a substantially cylindrical surface, a first face and a second face, said second face being adapted for insertion into said first end of said hollow shaft.

Said sealing plug also comprises:
a cavity that is open at said second face;
a first radial duct opening, at one of its ends, at said cavity and, at its opposite end, at said substantially cylindrical surface of said sealing plug.

Thanks to the invention, if the sealing plug is rotating, the lubricant contained in the chamber cannot infiltrate the hollow portion of the shaft. In fact, if a drop of lubricant were to infiltrate the radial duct during rotation thereof, the drop of lubricant would be subjected to a centrifugal force and would be immediately ejected outside, that is to say into the chamber. In other words, the lubricant cannot escape from the chamber via the hollow shaft. This particular detail makes it possible to ensure an optimum service life for the various mechanical elements comprised by the chamber.

Furthermore, a passage permitting air to circulate between the hollow portion of the shaft and the chamber is formed by the cavity and the radial duct. This passage makes it possible to balance the pressures inside and outside the shaft, thus limiting the mechanical stresses exerted on said shaft.

In addition to the main features that have just been mentioned in the paragraph above, the sealing plug according to the invention may also have one or more of the additional features below, taken individually or in any technically feasible combination:
said sealing plug comprises a second radial duct, said second radial duct opening, at one of its ends, at said cavity and, at its opposite end, at said substantially cylindrical surface, said first duct and said second duct being coaxial. As a result of this feature, not a drop of lubricant can infiltrate the hollow portion of the shaft when the shaft is immobile. Admittedly, if said first and second radial ducts were positioned substantially vertically a drop of lubricant could infiltrate one of said ducts, but said drop would slide along the wall of the ducts in order to exit said ducts and return to said chamber;
said first radial duct and said second radial duct have a diameter strictly less than 5 mm;
said first radial duct and said second radial duct have a length strictly greater than 15 mm;
said first radial duct and said second radial duct have a length strictly greater than 30 mm;
said cavity in said sealing plug does not open at said first face; in other words said cavity does not pass through said sealing plug completely, it does not open at the side of said chamber containing lubricant;
said cavity has a diameter between 5 and 10 mm;
said hollow shaft and said cavity are coaxial.

The invention also relates to a hollow shaft comprising a first end in which a hermetic sealing plug is inserted and a second end in which a sealing plug according to the invention is inserted.

The hermetic plug advantageously prevents hot air originating from the outside (for example from a turbine) from infiltrating the hollow portion of the shaft, thus maintaining the quality of the lubricant when the first end is arranged in a chamber filled with lubricant and the second end is connected to a turbine.

The invention further relates to a turbomachine comprising a hollow shaft according to the invention.

Further features and advantages of the invention will become clear upon reading the following description, given by way of non-limiting indication and with reference to the accompanying drawings, in which:

FIG. 1 is a schematic view of an example of a turbine engine according to the prior art;

FIG. 2 is a schematic, partial view of a turbomachine equipped with a sealing plug according to the invention;

FIG. 3 is a schematic, three-dimensional, sectional view of a hollow shaft comprising a plug according to the invention.

For reasons of clarity, only those elements beneficial for comprehension of the invention have been shown, more specifically schematically and with no regard for scale.

Furthermore, like elements illustrated in different figures are denoted by like reference numerals.

FIG. 1 has been described above in order to illustrate the prior art.

FIG. 2 is a partial view of a turbomachine 20 equipped with an open rotor comprising a hollow shaft 22 equipped with a sealing plug 21 according to the invention and a hermetic sealing plug 28. For reasons of clarity, the open rotor is not shown.

More specifically, FIG. 2 shows part of a hollow shaft 22 comprising a first end 23 and a second end 24.

The first end 23 is connected mechanically to a speed reducer 26 (also known as a gearbox) within a chamber 25 filled with a mixture of air and lubricant 27.

The second end 24 is positioned outside the chamber 25 and is more specifically connected to a turbine (not shown).

In other words, in the example shown in FIG. 2, the hollow shaft 22 is a turbine shaft adapted for rotating the speed reducer 26.

It should also be noted that the sealing plug 21 according to the invention is positioned at the first end 23 of the hollow shaft 22 and that the hermetic sealing plug 28 is positioned at the second end 24 of the hollow shaft 22. The sealing plug 21 and the hermetic plug 28 may be joined to the hollow shaft 22 by any type of means, for example by screwing or by a snap ring.

More specifically, a three-dimensional, sectional view of the sealing plug 21 is illustrated in FIG. 3.

The sealing plug 21 comprises a substantially cylindrical lateral surface 30 connecting a first face 31 and a second face 32. Said sealing plug 21 further comprises a cavity 33 that opens at the second face 32 and is centred on the axis x of the hollow shaft 22. In other words, the cavity 33 communicates with the interior of the shaft 22. The cavity 33 is substantially cylindrical. In our example, the cavity 33 does not pass through the sealing plug 21 completely; it does not open at the opposite side, i.e. at the first face 31.

As shown in FIG. 3, the sealing plug 21 also comprises a first radial duct 34 (i.e. a duct extending perpendicular to the shaft of the plug 21 and from the shaft of the plug 21) and a second radial duct 35, which are arranged so as to be mutually opposed. More specifically each radial duct 34, 35 opens, at one of its ends, at the substantially cylindrical surface 30 (i.e. into the chamber 25) and, at its opposite end, at the cavity 33.

As a result, air can circulate through the chamber 25 towards the interior of the shaft 22 or vice versa via:
the cavity 33 and the first radial duct 34;
the cavity 33 and the second radial duct 35, it being understood that the number of radial ducts 34, 35 may be less (i.e. one duct) or more.

When the hollow shaft 22 is rotated by the turbine (not shown), a drop of lubricant contained in the chamber 25 can infiltrate one of the radial ducts 34 or 35. This drop of lubricant is collected in the radial duct 34 or 35 and then ejected, under the effect of the centrifugal force, into the chamber 25 via the same radial duct.

The ducts 34 and 35 are generally radial, thus any drop of lubricant that infiltrates them during rotation of the sealing plug 21 is immediately centrifuged and thus immediately discharged into the chamber 25. Consequently, when the sealing plug 21 is rotating, the lubricant contained in the chamber 25 cannot escape therefrom by passing into the interior of the shaft 22 and also cannot collect inside said shaft. The efficiency of the sealing plug 21 increases if the radial ducts 34 and 35 are longer, very thin and rotate relatively quickly. For example the shaft 22 may be subjected to a speed of rotation approaching 6500 rpm.

The diameter of the radial ducts 34 and 35 may be, for example, between 2 mm and 5 mm. The diameter of the radial ducts 34 and 35 is preferably approximately 2 mm.

Furthermore, the length of these ducts may be between 15 mm and 40 mm.

In addition, if the hollow shaft 22 is immobile and the radial ducts 34 and 35 are positioned substantially vertically, it is still possible for a drop of lubricant to infiltrate one of said ducts. However, since the two radial ducts 34 and 35 are coaxial, if a drop of lubricant were to infiltrate one of the radial ducts 34 or 35 via one of the ends thereof, it would slide along the wall and return to the chamber 25.

If the drop of lubricant were to remain stuck to a wall of one of the radial ducts 34 or 35, it would be ejected upon rotation of the hollow shaft 22.

To summarise, thanks to the sealing plug 21 of the invention, the lubricant contained in the chamber 25 cannot exit said chamber via the hollow shaft 22, whether said shaft is rotating or stationary.

Furthermore, since the two radial ducts 34 and 35 as well as the cavity 33 communicate with the interior of the shaft 22, the pressure exerted inside the shaft 22 is substantially equal to the pressure exerted outside the shaft 22. In fact, the radial ducts 34 and 35 as well as the cavity 33 make it possible, in addition for the lubricant to be contained in the chamber 25, to balance the pressures inside and outside the shaft 22 so as to minimise the mechanical stresses that may be exerted in the shaft 22.

Furthermore, as shown in FIG. 2, the hollow shaft 22 comprises, on its first end 23, the sealing plug 21 and, on its second end 24, a hermetic plug 28 adapted to prevent air originating from the outside (for example from a turbine) from infiltrating the shaft 22. The hot air generated by the turbine thus cannot infiltrate said shaft and therefore cannot cause the temperature of the lubricant to rise. This feature makes it possible to preserve the quality of the lubricant, thus ensuring an optimum service life of the mechanical components comprised by the chamber 25, for example gears and bearings. The hermetic plug 28 may be joined to the hollow shaft 22 by any type of means, for example by screwing or by a snap ring.

To summarise, the sealing plug 21 and the hermetic seal 28 according to the invention make it possible:
to prevent a flow of hot air (generated by the turbine) from circulating in the hollow shaft 22 and beneath the chamber 25 and/or in the chamber 25 containing lubricant;
to prevent retention of lubricant in the hollow shaft 22, which could trigger coking and/or an imbalance during rotation of said shaft;
to balance the pressures exerted on the inner and outer walls of the hollow shaft 22.

In addition, the invention has been described more particularly for application with a turbomachine and, more specifically with a turbine shaft connecting a reducer to a turbine. However, it could also be desirable to apply the same sealing plug in the case of any type of chamber containing a lubricant and into which a hollow shaft that can be rotated is inserted.

The invention has been described above by way of example, although it is understood that the person skilled in the art will be able to embody different variants of the device according to the invention, in particular with regard to the number or sizes of the radial ducts as well as the positioning of the cavity, without departing from the scope of the patent.

1. A sealing plug for a hollow shaft used to impart a rotational speed, said hollow shaft comprising:
a first end adapted to be located in a chamber containing lubricant;
a second end adapted to be located outside said chamber;
said sealing plug having a substantially cylindrical surface, a first face and a second face, said second face being adapted for insertion into said first end of said hollow shaft;
a cavity that is open at said second face;
a first radial duct opening, at one of its ends, at said cavity and, at its opposite end, at said substantially cylindrical surface of said sealing plug.

2. The sealing plug according to claim 1, comprising a second radial duct, said second radial duct opening, at one of its ends, at said cavity and, at its opposite end, at said substantially cylindrical surface, said first duct and said second duct being coaxial.

3. The sealing plug according to claim 2, wherein said first radial duct and said second radial duct have a diameter strictly less than 5 mm.

4. The sealing plug according to claim 2, wherein said first radial duct and said second radial duct have a length strictly greater than 15 mm.

5. The sealing plug according to claim 2, wherein said first radial duct and said second radial duct have a length strictly greater than 30 mm.

6. The sealing plug according to claim 1, wherein said cavity in said sealing plug does not open at said first face.

7. The sealing plug according to claim 1, wherein said cavity has a diameter between 5 mm and 10 mm.

8. The sealing plug according to claim 1, wherein said hollow shaft and said cavity are coaxial.

9. A hollow shaft comprising a first end, into which a sealing plug according to claim 1 is inserted, and a second end, into which a hermetic seal is inserted.

10. A turbomachine comprising a hollow shaft according to claim 9.
